(19) United States
(12) Patent Application Publication
(10) Pub. No.: US 2016/0075053 A1
(43) Pub. Date: Mar. 17, 2016

(54) SYSTEMS AND METHODS FOR DRYING PELLETS AND OTHER MATERIALS

(71) Applicant: GALA INDUSTRIES, INC., Eagle Rock, VA (US)

(72) Inventors: J. Wayne Martin, Buchanan, VA (US); Matthew Jean Tornow, Troutville, VA (US)

(21) Appl. No.: 14/855,614

(22) Filed: Sep. 16, 2015

Related U.S. Application Data
(60) Provisional application No. 62/051,226, filed on Sep. 16, 2014.

(51) Int. Cl. B29B 13/06; B65B 1/00; B29B 9/06

(52) U.S. Cl. CPC B29B 13/065; B29B 9/06; B65B 1/00; B29K 2101/12

(57) ABSTRACT

Systems and methods for manufacturing pellets are disclosed herein. The systems and methods can include improved drying systems and techniques. In some embodiments, for example, the systems and methods can make use of one or more vacuum dryers and various other improvements related thereto.

### CROSS REFERENCE TO RELATED APPLICATIONS

This application claims the benefit of U.S. Provisional Application No. 62/051,226, titled “SYSTEMS AND METHODS FOR DRYING PELLETS AND OTHER MATERIALS,” filed Sep. 16, 2014, and which is fully incorporated by reference.

### BACKGROUND

1. Field of the Invention

The present invention relates to pelletizing systems and methods, and more specifically, to drying pellets and other materials during or after manufacturing.

2. Description of Related Art

Several types of pelletizing systems are known, including pelletizing systems having dryers and other related components to remove fluid from the pellets during or after manufacturing. In some circumstances, however, known systems may not remove a sufficient quantity of the fluid, or may not remove the fluid quickly enough, or may be overly expensive to purchase or operate. In other cases, the known systems may not be compatible with the size, shape, or type of material to be dried. In still yet other cases, the dryers may be specifically designed for batch drying of materials, and thus cannot handle a continuous flow of material to be dried. Accordingly, there is a need for improved systems and methods to dry pellets, and embodiments of the present disclosure are directed to this and other considerations.

### SUMMARY

Briefly described, embodiments of the present disclosure can comprise pelletizing systems, or more specifically, micro-pelletizing systems, employing a de-fluidizing section, an optional conveying section, one or more vacuum dryers, and optionally, any subsequent conveying and/or packaging sections. In embodiments employing more than one vacuum dryer, the system can comprise a valve, such as a flapper valve or a rotary valve, to direct pellets into the vacuum dryers. In systems employing one or more vacuum dryers with a heating hopper for each dryer, a holding container or staging container can be employed to continuously receive materials from the pelletizer or dewatering section, and a flapper valve or rotary valve can direct pellets into each heating hopper as it is emptied into its associated vacuum chamber.

In the drying of micro-pellets, certain problems arise with conventional dryers, such as centrifugal dryers used for drying standard size pellets. Problems such as clogging of screens with the much smaller pellets, leakage of pellets at every joint and seam in the dryer, and the need to de-rate the dryer due to the lower open areas of the finer screens employed for micro-pellets, plague the use of centrifugal dryers for use with micro-pellets. Vacuum dryers, having fewer moving parts, and no impact between pellets and screens, obviate some of the problems associated with centrifugal dryers. Further, while centrifugal dryers are efficient at removing surface moisture from standard size pellets, they do little to remove internal moisture from these same pellets. Vacuum dryers also overcome this deficiency of the centrifugal dryer.

Further features of the invention, and the advantages offered thereby, are explained in greater detail hereinafter with reference to specific embodiments illustrated in the accompanying drawings, wherein like elements are indicated by like reference designators.

### BRIEF DESCRIPTION OF THE DRAWINGS

FIG. 1 is a schematic view of a pelletizing system in accordance with some embodiments of the present disclosure.

FIG. 2 is a schematic view of a vacuum dryer in accordance with some embodiments of the present disclosure.

FIG. 3 shows an exemplary embodiment having multiple vacuum dryers arranged in series,

FIG. 4 shows an exemplary embodiment wherein a single heating hopper distributes material to multiple vacuum chambers, and

FIG. 5 shows an exemplary embodiment with multiple vacuum dryers arranged in parallel and having a single staging hopper and distribution valve.

### DETAILED DESCRIPTION

To facilitate an understanding of the principles and features of the various embodiments of the invention, various illustrative embodiments are explained below. Although exemplary embodiments of the invention are explained in detail as being systems and methods related to pelletizing and drying of pellets, it is to be understood that other embodiments are contemplated, such as embodiments employing the manufacturing and drying of micro-pellets, crumbs, powders, beads, chips, granules, flakes, and other particulate materials. Accordingly, it is not intended that the invention is limited in its scope to the details of construction and arrangement of components set forth in the following description or examples. The invention is capable of other embodiments and of being practiced or carried out in various ways. Also, in describing the exemplary embodiments, specific terminology will be resorted to for the sake of clarity. In this regard, the term “fines” is understood to be any material smaller than the intended particles to be dried, and is an undesirable material to have accompanying the intended particles.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

To facilitate an understanding of the principles and features of this disclosure, various illustrative embodiments are explained below. In particular, various embodiments of this disclosure are described as systems and methods for pelletizing with an improved drying system and technique. Some embodiments of the invention, however, may be applicable to other contexts, and embodiments employing these applications are contemplated.

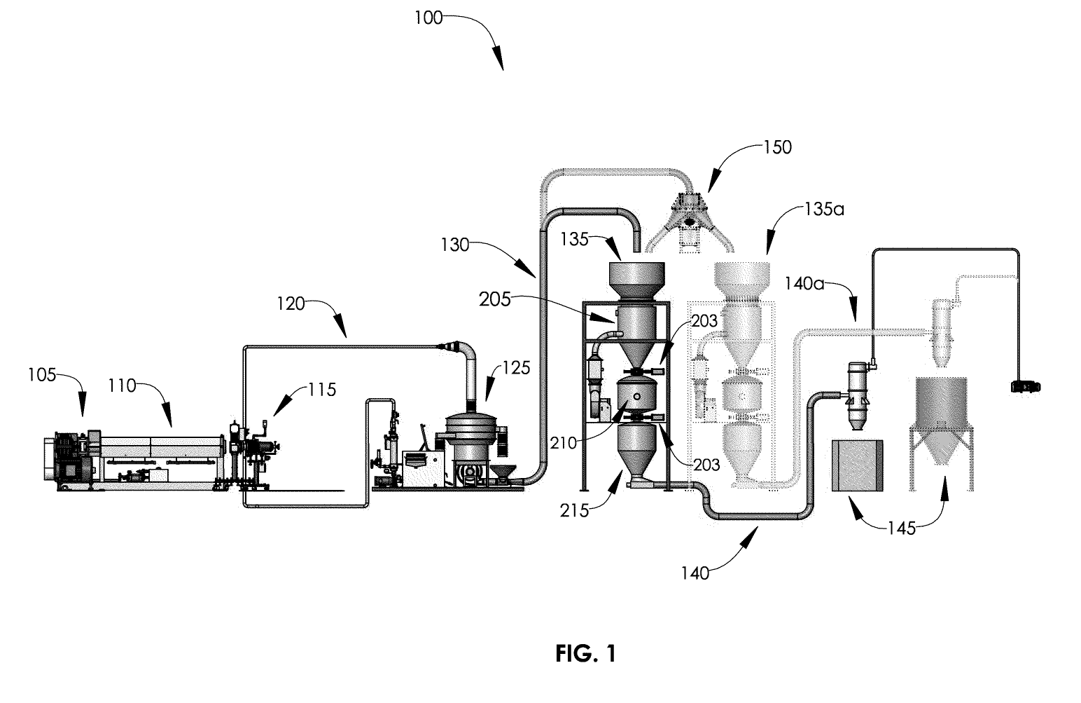

An exemplary pelletizing system 100 of this disclosure is shown in FIG. 1. The pelletizing system 100 can include at least one feeding or filling section 105 that provides material into a mixing, melting and/or blending and extrusion section 110 (the “extrusion section 110”). It should be understood that extrusion section 110 is just an example of one type of material pre-processing system. Other equivalent devices that could replace extrusion section 110 are melt vessels, or reactors with melt pumps. Section 110 can also include one or more of devices such as heat exchangers, melt coolers, filters or screen changers, and/or polymer diverter valves. The extrusion section 110 can be coupled to a pelletizing section 115, such as an under-fluid pelletizing section, a water-ring pelletizing section, a strand pelletizing section, and the like, to pelletize the material. In some embodiments, the pelletizing section can be connected to a first transport component 120, such as an under-fluid transport system, to move the pelletized material. Optionally, the transport component 120 can move the pelletized material to one or more of a conditioning system, a classifying system, an agglomerate catcher or agglomerate removal system, and/or to a de-fluidizing section 125. Conditioning systems could be in the form of the iHeat process, described in U.S. publication number 2012/0228794, the CPT and PCS processes described in U.S. Pat. Nos. 7,157,032, 8,366,428, 8,080,196, 8,361,364, and 9,032,641, and the positionable nozzle for gas injection system described in U.S. Pat. Nos. 8,007,701 and 8,011,912, all owned by the present Assignee and hereby incorporated by reference. The de-fluidizing section 125 can remove the fluid from the pelletized material, or can begin the process of removing the fluid from the pelletized material. The de-fluidizing section 125 can feed into a second transport component 130 to move the pelletized material to a dryer 135, such as, for example, a vacuum dryer. The dryer 135 can finish the pellet drying process and feed into a third or final transport component 140 to move the pelletized material to a final station or stations 145 for packaging, bagging, storage, or other use.

As shown in reduced shading in FIG. 1, the pelletizing system 100 can optionally include more than one dryer 135. In such pelletizing systems 100, the second transport component 130 can feed into a diverter valve 150, such as a “Y” shaped flapper valve, or a rotary valve of the type shown in U.S. Pat. No. 8,863,931, as an example. The valve 150 can then feed into two or more dryers 135, 135a, etc. Each of the dryers 135, 135a, etc., can then feed dried pellets into transport components 140, 140a, etc., which can each move the pelletized material to a final station or stations for packaging, bagging, storage, or other use.

In addition, the layout of the pelletizing system 100 discussed above and as shown in FIG. 1 can vary. This variation in possible layout can alleviate the need for certain components of the pelletizing system 100, or require additional components. For example, in some embodiments, the de-fluidizing section 125 can be mounted above the dryer 135 or above the diverter valve 150. Thus, the pellets can be fed into the dryer 135 or diverter valve 150 directly from the de-fluidizing section 125, by gravity, alleviating the need for the transport component 130.

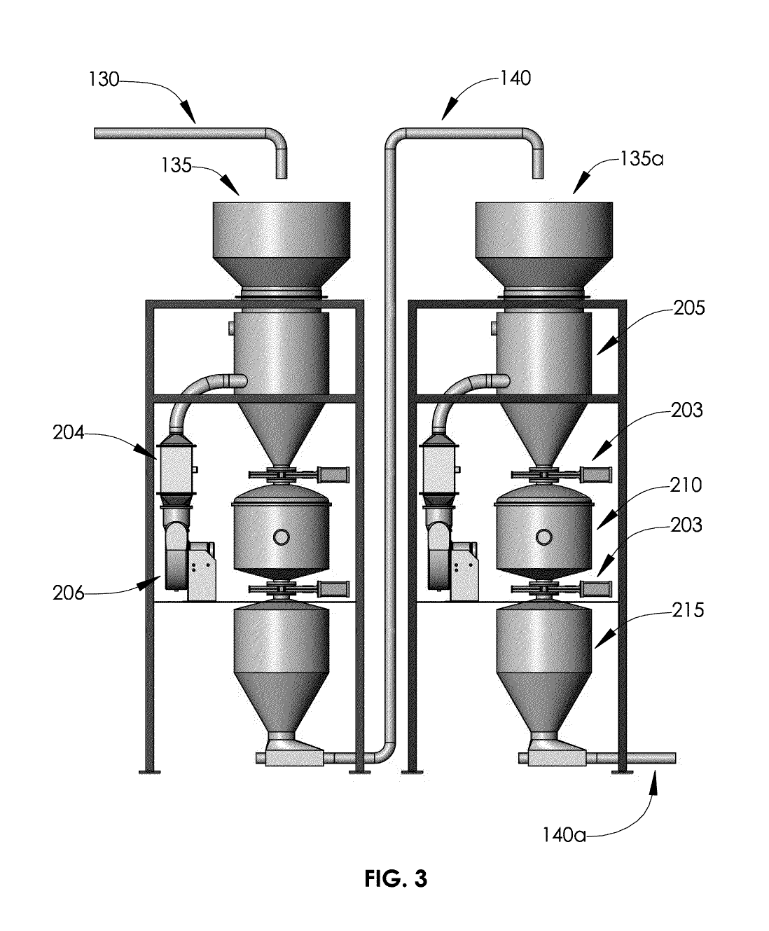

FIG. 3 shows an exemplary embodiment where material leaving vacuum dryer 135 may not have reached a predetermined dryness level required for the purposes of the material being dried. In some embodiments, further dryers, such as 135a, etc., may be arranged in series, wherein the output of dryer 135 becomes the input for dryer 135a via third transport component 140, and the output of dryer 135a becomes the input of the next dryer via next transport component 140a, etc., until the predetermined dryness level is reached.

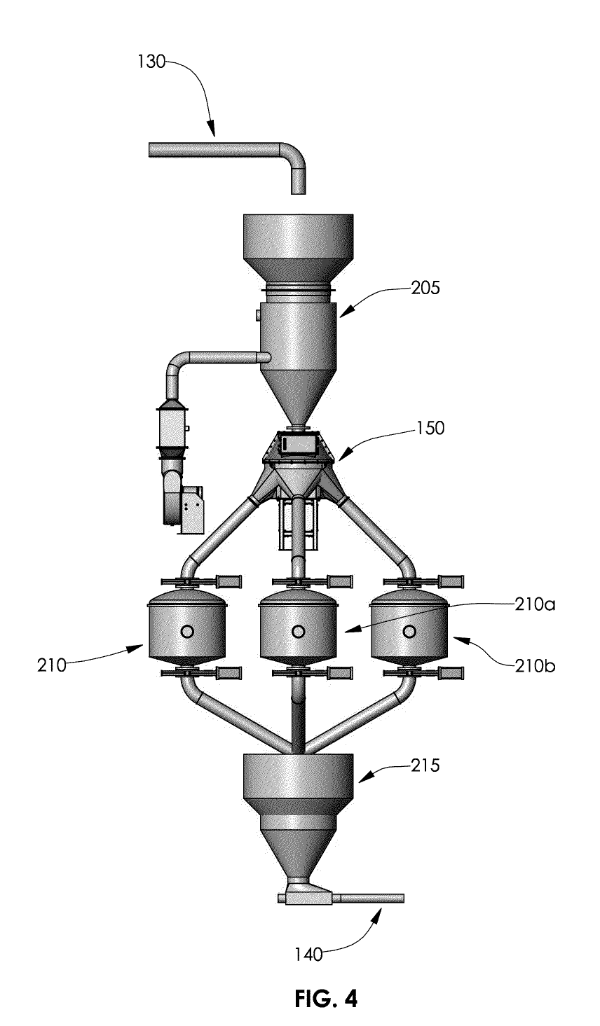

FIG. 4 shows another exemplary embodiment, wherein one large heating hopper section 205 may be configured to continuously receive dewatered material via the second transport component 130. In turn, heating hopper 205 may be configured to dispense material to multiple vacuum vessels 210, 210a, 210b, etc. by way of a diverter valve 150. As each of the vacuum vessels 210, 210a, etc. finishes its drying cycle, dried material may be released to third or final transport component 140 for transporting to packaging or storage section 145. The now empty vacuum vessel 210, 210a, etc. may be refilled from heating hopper 205 by way of diverter valve 150, such that there is a continuous flow of material through the system.

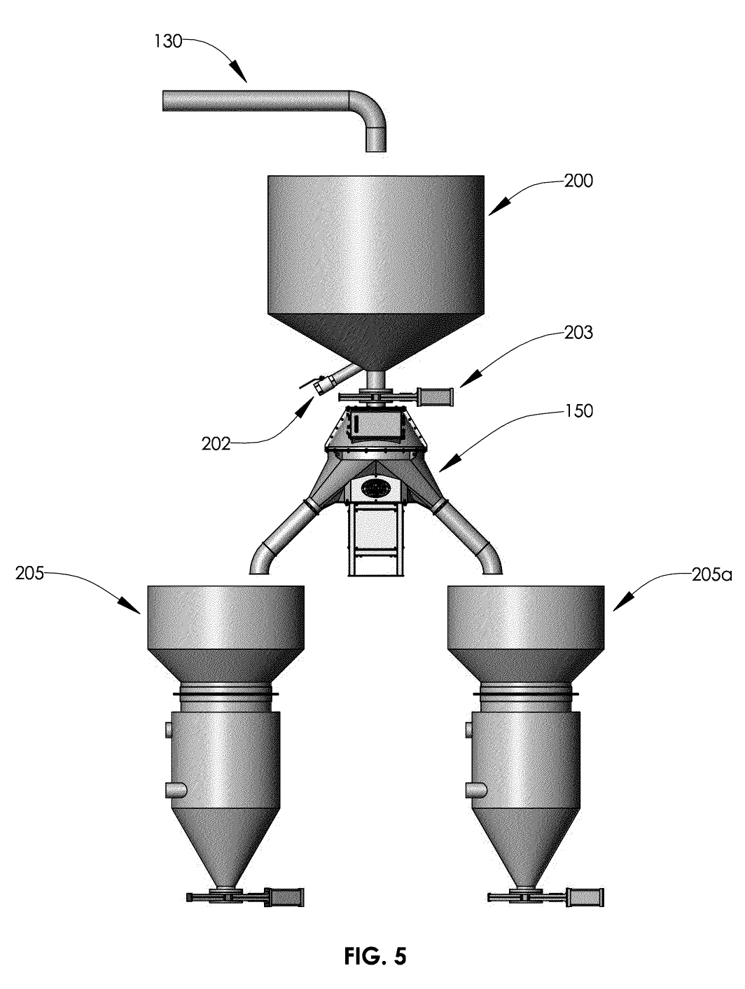

In FIG. 5, an arrangement is shown wherein a single staging hopper 200 may be configured to continuously receive dewatered material from de-fluidizing section 125 by way of the second transport component 130. The staging hopper 200 may be sufficiently sized to continuously receive material at the rate at which it leaves de-fluidizing section 125 without overflowing. A drain assembly 202 can be arranged in the bottom of staging hopper 200 to allow any fluid still coming off of the de-fluidized material to be drained away, before the material is discharged to a heating hopper 205. An open/close type valve 203 can be added to the very bottom of staging hopper 200 to control the exit of material from staging hopper 200 into heating hopper 205. Alternatively, open/close type valve 203 can control exit of material from staging hopper 200 into flapper or rotary valve 150, which then directs the material to heating hoppers 205, 205a, etc. as needed. Flapper valve or rotary valve 150 may conduct de-fluidized material from staging hopper 200 to one or more heating hoppers 205, 205a, etc., as each heating hopper 205, 205a, etc. is emptied into its associated vacuum vessel 210, 210a, etc. by means of open/close type valve 203. By this means, a continuous flow of material can be stored in staging hopper 200 before being delivered in batches to heating hopper or hoppers 205, 205a, etc. In this manner, the inter-mixing of cooler de-fluidized material from transport component 130 with warmer material already in heating hopper 205 can be prevented.

In some embodiments, a single vacuum dryer 135 is used, and the size of the staging hopper 200 may hold slightly more material than the flow rate of material through transport component 130 times the amount of time needed to dry one batch of material in vacuum vessel 210. In this embodiment, the rotary valve or flapper valve 150 may not be needed. In other embodiments, multiple vacuum dryers 135 are used in parallel, the staging hopper 200 may be sized accordingly, and the rotary valve or flapper valve 150 may be configured to direct material to each heating hopper 205, 205a, etc. as its corresponding vacuum vessel is emptied by means of an open/close type valve 203, and the contents of the heating hopper are emptied by means of open/close type valve 203 into the now empty vacuum vessel. In this manner, an otherwise batch drying process of the vacuum dryer 135 acting alone can be converted into a continuous drying process. It should be understood that one or more staging hoppers may be used to effect continuous flow of material, and if more than one is used, a rotary valve or flapper valve may be connected to transport component 130 to direct de-fluidized material into each of the staging hoppers in turn. The control of the open/close type valves 203 and rotary valve(s) or flapper valve(s) 150 may be effected by a cycle control program, to cycle the de-fluidized material into and out of the staging hopper or hoppers, and into and out of the heating hopper or hoppers.

In some embodiments, the feeding or filling section 105, extrusion section 110, pelletizing section 115, and transport component 120 can be the same as, substantially the same as, or similar to known sections and/or systems, such as those related to under-fluid pelletization (such as underwater pelletization). However, embodiments where these sections and systems are optimized for particular applications, such as those described herein, are also contemplated by this disclosure. For example, the transport fluid used to transport the pellets or particles within transport component 120 may be water or water with additives, but other transport fluids are contemplated. Examples of other transport fluids are gaseous fluids such as air, nitrogen, or other gases, as well liquids such as oil, alcohol, glycerin, and other non-aqueous fluids.

In some embodiments, as mentioned above, the de-fluidizing section 125 can remove, or begin to remove, fluid from the pellets. After exiting the transport component 120, the pellets can have fluid on their surface and in some cases within their interior such as when the pellets comprise hygroscopic material. Examples of hygroscopic materials could be polycarbonates, polyesters, or polyamides, or they could be biomaterials such as polylactic acid, polyhydroxyalkanoates, polybutylene succinate, etc., and/or their additives added in the pre-pelletizing processes. The presence of this fluid can originate with the pelletizing section 115, which can comprise an under-fluid pelletizer, and/or the transport component 120, which can comprise an under-fluid transport system. In some embodiments, the fluid can be water, but can also be other fluids, or can be water with other ingredients mixed therein.

In some embodiments, the de-fluidizing section 125 can comprise a screen device. The screen device can comprise one or more vibrating screens. The transport component 120 can be fluid transport pipes or passages of short or long length, and can include pellet conditioning processes as described in the above mentioned patents and applications. The transport component 120 can provide a flow of fluid and pellets onto the vibrating screens, and the fluid can flow through the screen, off of and away from the pellets. The pellets can be agitated on the vibrating screens, and the vibration of the screens can cause excess fluid to drain off the pellets and fall through the screens. In some embodiments, the screens can be layered to allow smaller pellets to fall through the top screen(s), which can have larger gaps, onto lower screen(s), which can have smaller gaps. In this manner the screens can separate the pellets by size while de-fluidizing the pellets. The vibration can also cause the pellets to move along the screens, while being de-fluidized, to an exit area of the screen device.

In some embodiments, the screen device can comprise a screen disposed at an angle to the horizontal. In these embodiments, the transport component 120 can provide a flow of fluid and pellets onto the angled screen. Thus, the fluid can flow through the angled screen as the angled screen directs the pellets away from the fluid and to an exit area of the screen device.

Similarly, in some embodiments, the de-fluidizing section 125 can comprise a fines removal sieve to remove fines, or excess material, from the fluid/pellet flow. Moreover, in some embodiments, the de-fluidizing section 125 can comprise forced or heated air convection systems, rotational drying systems such as a tumbler, or a fluidized bed. In some embodiments, the de-fluidizing section 125 can comprise an agglomerate catcher to remove agglomerates from the pellet flow. Alternatively, in other embodiments, the agglomerate catcher can be separate from the de-fluidizing section 125.

In some embodiments, the de-fluidizing section 125 can comprise an inclined screw conveyor dewatering device. The inclined screw conveyor can have an inlet at a lower portion thereof for receiving the slurry of fluid and particulate material, and a screw conveyor that conveys the slurry. As the screw conveys the slurry upwards on an incline, the transport fluid is allowed to drain therefrom. At the topmost portion of the screw conveyor, substantially dewatered material is discharged into transport component 130, or is discharged directly into staging hopper 200 or heating hopper 205. In a similar manner, de-fluidizing section 125 and transport component 130 can be combined into one structure which itself can comprise an inclined screw conveyor dewatering device, as described above.

In some embodiments, the de-fluidizing section 125 can comprise a centrifugal dryer. The centrifugal dryer can comprise a rotor with lifting blades and a screen surrounding the circumference of the rotor. The pellets can be fed into the bottom of the centrifugal dryer and the rotation of the lifting blades can “sweep up” the pellets and move the pellets vertically upward. As the pellets are swept upward, the pellets can ricochet off the screen surrounding the rotor. This ricocheting serves to beat the water off of the pellets, thereby drying them. The pellets may then exit near the top of the centrifugal dryer. Some centrifugal dryers are known, and in some applications these dryers can be used to completely dry the pellets, or dry the pellets as well as possible given certain processing conditions. In some embodiments of the present disclosure, however, a smaller and less expensive centrifugal dryer can be employed in the de-fluidizing section 125. Such a centrifugal dryer can remove bulk fluid from the pellets without completely drying the pellets.

Upon exiting the de-fluidizing section 125, the pellets can be fed into the transport component 130. The transport component 130 can then direct the pelletized material to a dryer 135. In some embodiments, the transport component 130 can comprise a blower, such as a pneumatic blower, to blow the pellets through a pipe or passage to the dryer 135. In some embodiments, the transport component 130 can further comprise a cyclone separator to separate the pellets from the air (and any unwanted, smaller materials) at the end of the pipe or passage. In some embodiments, the transport component 130 can comprise a screw conveyor, such as a flexible screw conveyor, or other types of conveyors, such as a belt conveyor, bucket conveyor, and/or vacuum conveyor, and the like.

In an exemplary embodiment, the de-fluidizing section, regardless of the form it takes, may be configured to discharge de-fluidized material having a total moisture content no greater than approximately 15% moisture by weight. For example, the defluidized material may have a total moisture content of no greater than approximately 15% moisture by weight before being discharged into the staging hopper 200 or heating hopper 205. In further embodiments, for example with materials that have mainly surface moisture thereon, the defluidizing section 125 may be configured to discharge the de-fluidized material with a moisture content no greater than approximately 3%. Materials with moisture levels greater than these indicated levels may pose significant problems to the vacuum dryer 135. These problems can include, for example, fluid continuing to drain from the material and out of the heating hopper, flowability of wet material being less than that of dryer material, and longer heating times to preheat the wet material in the heating hopper. Additionally, higher moisture levels of the material entering the heating hopper 205 may require increased time and/or energy to reach predetermined final moisture level in some embodiments of no more than approximately 0.1%, and of no more than approximately 0.05% in other embodiments, of the material as it leaves the vacuum vessel 210. Therefore, it can be seen that the choice of de-fluidizing means 125 may be critical for the material being dried, and for the optimum performance of vacuum dryer 135.

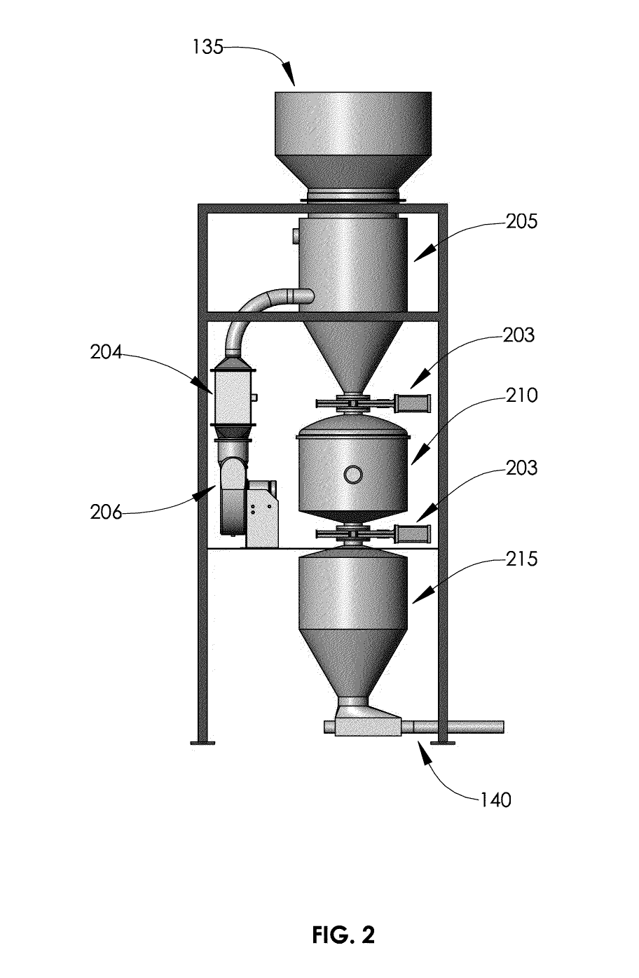

As mentioned above, the transport component 130 can feed the pellets into a dryer 135. In some embodiments, the dryer 135 can be a vacuum dryer. Accordingly, as shown in FIG. 2, the dryer can comprise an inlet and/or heating hopper 205 (the “heating hopper 205”), a vacuum vessel 210, and an exit system 215. The heating hopper 205 can be in communication with a heat source configured to direct hot air into the heating hopper 205. In some embodiments, the heat source can comprise a blower 206 and a heating element 204, with the blower configured to blow air over the heating element and into the heating hopper 205. As the hot air is blown into and through the pellets in heating hopper 205, it mixes with the pellets to distribute the heat relatively evenly throughout the pellets. Heating element 204 can be an electrical element, or can be some form of air/fluid heat exchanger utilizing steam, hot water, hot oil, combustion gases, etc. as the fluid medium. It is contemplated that the airflow rate of the blower 206 can be varied to optimize preheating performance. In some embodiments, to aid the “pre-drying” process, the heating hopper 205 can comprise a screen or other drainage feature to enable liquid on the pellets to drain out of the heating hopper 205. Moreover, in some embodiments, the heating hopper 205 can comprise a mixer to mix the pellets as they are being heated in the heating hopper 205. In this fashion, the mixer can disperse the heat in the heating hopper 205 relatively evenly to the pellets. In some embodiments, a second de-fluidizing section 125 (or the only de-fluidizing section 125) may be placed above the heating hopper 205 to further de-fluidize the pellets before the pellets enter the heating hopper 205.

The vacuum vessel 210 can receive the heated pellets from the heating hopper 205 upon actuation of open/close type valve 203. Subsequently, the vacuum vessel 210 can be sealed and undergo a reduction in its internal pressure such that the pellets are subject to lower than ambient pressures. This can enable any liquid on or within the pellets to boil and the gas to be removed, thereby removing the liquid from the pellets. To aid in the boiling and drying process, the vacuum vessel can comprise one or more heating elements, or heated jackets such as for steam or hot oil heating, to heat the pellets and any moisture thereon.

After the pellets are dried, the vacuum vessel 210 can discharge the pellets into an exit system 215 upon actuation of open/close type valve 203. In some embodiments, the exit system 215 can comprise a funnel feeding into the third or final transport component 140. Alternatively, in other embodiments, the exit system 215 can comprise a hopper for collection of the pellets before subsequent packaging or storage.

In embodiments where the exit system 215 feeds the pellets into the third or final transport component 140, the transport component 140 can direct the pelletized material to a final station or stations 145 for packaging, bagging, storage, or other use. In some embodiments, transport component 140 can comprise a blower, such as a pneumatic blower, to blow the pellets through a pipe or passage to the final station 145. In some embodiments, the transport component 140 can further comprise a cyclone separator to separate the pellets from the air (and any unwanted, smaller materials) at the end of the pipe or passage. In some embodiments, the transport component 140 can comprise a screw conveyor, such as a flexible screw conveyor, or other types of conveyors, such as a belt conveyor, bucket conveyor, and/or vacuum conveyor, and the like. In an alternate embodiment, FIG. 3 shows material leaving vacuum dryer 135 which may not have reached the dryness level required for the purposes of the material being dried. In this exemplary embodiment, further dryers, such as 135a, etc., may be arranged in series, wherein the output of dryer 135 becomes the input for dryer 135a via third transport component 140, and the output of dryer 135a becomes the input of the next dryer via next transport component section 140a, etc., until the desired dryness level is reached, and the dried material is finally conveyed to final station 145.

As mentioned above, at final station 145 the pellets can be packaged, bagged, put into containers for storage, or otherwise made available for future use.

The dryer 135 described above can have a multitude of specifications and different arrangements. For example, in some embodiments, a vacuum dryer can comprise a larger or smaller inlet and/or heating hopper 205, depending on the optimum size for a particular application Likewise, the size and capacity of the vacuum vessel 210 and the exit system 215 can be optimized for particular applications. Also, multiple vacuum dryers 135 can be arranged in parallel or in series, or multiple vacuum chambers 210 can be so arranged, as needed for the particular applications.

In addition, the vacuum pressures within the vacuum vessel 210 can be optimized for particular applications. In some embodiments, for example, the pressure in the vacuum vessel 210 can be lowered from about 1 atmosphere or about 760 mm Hg to about 70 mm Hg, +/−20 mm, but achieving greater vacuums will obviously result in lower moisture levels or reduced drying time. It should be understood that lowering the pressure in vacuum vessel 210 to any pressure below atmospheric pressure will, in effect, lower the boiling point temperature of fluids on or within the material therein, relative to the boiling point temperature of the fluid at atmospheric pressure. Therefore, it is contemplated that the pressure may be lowered to a value anywhere greater than 0 mm Hg and less than atmospheric pressure within vacuum vessel 210, as appropriate for the equipment being used and the material being dried. In some embodiments, the pressure can be maintained at a relatively constant level throughout the vacuum cycle time of the vacuum vessel 210 or can be varied throughout the vacuum cycle time of the vacuum vessel 210. In circumstances where the pressure is varied, the changes in pressure can enable moisture trapped between or within the pellets to work its way out from between the pellets or within the pellets. Accordingly, the strength of the vacuum pump attached to the vacuum vessel 210 can be varied based on the needs of a particular application, to ensure that the requisite pressures can be achieved for the requisite amount of time. Moreover, the vacuum cycle time, or the amount of time that the pellets spend in the vacuum vessel, can vary from about 5 minutes to about 6 hours, but in some embodiments can be about 10 minutes to about 30 minutes or about 15 minutes to about 20 minutes. This can provide a shorter, improved drying time when compared to many known methods of drying pellets, especially when compared to known batch drying method.

For some applications, the use of a vacuum dryer can present significant advantages. For example, in some circumstances, a vacuum dryer can dry pellets in less time than other types of dryers (such as desiccant dryers or fluid bed dryers), thereby saving time. In addition, in some circumstances, a vacuum dryer can use less energy than other types of dryers while drying the pellets the same amount, thereby reducing energy cost. Vacuum dryers can also have fewer moving parts than other types of dryers, which can reduce the amount of dryer maintenance required. Moreover, vacuum dryers do not beat or vibrate the moisture off of the pellets, and can therefore be less likely to change the shape of the pellets or damage the surface structure of the pellets during drying. Finally, in some cases, vacuum dryers can dry pellets to lower moisture levels than other types of dryers.

In addition, the systems and methods described herein, including those using a vacuum dryer, can be used in a variety of scenarios. For example, the systems and methods described herein can be employed with a variety of pellets. In some embodiments, the systems and methods described herein can be employed with pellets made from hygroscopic and/or non-hygroscopic materials. It is believed that the vacuum dryers are efficient and effective at drying pellets made from non-hygroscopic materials, such as polyethylene or polypropylene, because the vacuum can cause moisture on the pellets' surface to quickly boil off of the surface. Additionally, in some embodiments, the vacuum can help pull moisture out of the interior of hygroscopic materials, thereby effectively drying pellets made from hygroscopic materials as well.

Moreover, the systems and methods described herein, including those using a vacuum dryer, can be used with a variety of pellets. For example, the systems and methods described herein can be used to manufacture and/or dry spherical pellets, hollow pellets, lenticular pellets, or cylindrical pellets, to name some examples. Moreover, the systems and methods described herein can be used to manufacture and dry micro-pellets. Micro-pellets can be those pellets which have a cross-sectional size of 1.0 mm or smaller. Because micro-pellets are smaller, they typically have larger surface area to internal area ratios, which can make micro-pellets more difficult to dry. Moreover, micro-pellets have less mass than larger pellets, which makes them more difficult to dry in a centrifugal dryer, since the lower mass makes it difficult to “beat” the liquid off the pellets. However, since the vacuum vessel 210 can exert vacuum pressures and temperature relatively uniformly over the surface of the pellets in the vacuum vessel 210, the use of a vacuum dryer can be more efficient than other methods of drying these smaller pellets.

The systems and methods described herein can also be used to manufacture and dry pellets having rough or uneven surface structure, such as pellets that undergo “melt facture” or, alternatively, such as crumb materials. These pellets/materials commonly have cracks on the surface within which moisture can become entrapped, making drying more difficult, especially with a centrifugal dryer. However, since the vacuum vessel 210 can exert vacuum pressures and temperature relatively uniformly over the entire surface of the pellets, including within the cracks or between rough areas, the use of a vacuum dryer can be more efficient than other methods of drying these pellets. The systems and methods described herein can also be used to manufacture and dry brittle pellets, which may break or deteriorate in a centrifugal dryer, due to impact.

When manufacturing and drying pellets, it can be important to manage the flow of the pellets through the pelletizing system 100. Specifically, in embodiments where the pelletization (or pellet-making) process is continuous, it can be important to ensure that the continuously manufactured and continuously flowing pellets have a place to go. This is especially true in systems that manufacture large quantities of pellets in a short amount of time. For example, it would not be desirable for the pellets to overflow the heating hopper 205. However, if the pellets in the vacuum vessel 210 are not yet dry, and thus the heating hopper 205 cannot yet empty into the vacuum vessel 210, this might be a concern, as the transport component 130 continues to feed pellets into the dryer 135.

Accordingly, the size of the dryer 135 can be carefully selected for a given application to ensure that desirable pellet flow will be maintained. Specifically, for those applications where a higher pellet flow rate is needed or desired, a larger dryer 135 can be employed. For applications where a lower pellet flow rate is needed or desired, a smaller dryer 135 can be employed.

In addition, in some embodiments, the pelletizing system 100 can optionally include more than one dryer 135, as discussed above. The use of more than one dryer 135 can provide another technique for ensuring that the pellets have a place to go, particularly in a continuous system. Moreover, in some cases, the use of more than one dryer 135 can be more efficient than the use of a larger dryer 135.

As discussed above, in a pelletizing system 100 employing more than one dryer 135, the transport component 130 can feed into a diverter valve 150, such as a “Y” shaped flapper valve or a rotary valve. The valve 150 can then feed into the two or more dryers 135, 135a, etc. In this fashion, batches of pellets can be dried in parallel, increasing the drying capacity of the system and ensuring that rapidly manufactured pellets are effectively processed by downstream components, such as the dryers 135, 135a, etc. Also, as discussed above with reference to FIG. 4, one large heating hopper section 205 can continuously receive dewatered material via transport component 130. Heating hopper 205 can be sized to continuously receive output from dewatering section 125. In turn, heating hopper 205 dispenses material to multiple vacuum vessels 210, 210a, 210b, etc. by way of a diverter valve 150. As each of the vacuum vessels 210, 210a, etc. finishes its drying cycle, dried material is released to third or final transport component 140 to be transported to packaging or storage section 145. The now empty vacuum vessel 210, 210a, etc. may be refilled from heating hopper 205 by way of diverter valve 150, such that there is a continuous flow of material through the system.

Further, as shown in FIG. 5, a staging hopper 200 can also be configured to receive a continuous flow of material, and then dispense the material to heating hopper or hoppers 205, 205a, etc. arranged singly or in parallel, as each empties into its corresponding vacuum vessel. By this means, a continuous flow of material can be stored in staging hopper 200 before being delivered in batches to heating hopper or hoppers 205, 205a, etc. In this manner, the inter-mixing of cooler de-fluidized material from transport component 130 with warmer material already in heating hopper 205 can be prevented.

It will be appreciated by those skilled in the art that the invention can be embodied in other specific forms without departing from the spirit or essential characteristics thereof. For example, while the invention has been described in the context of pellets, pelletizing, and drying pellets, the concepts described herein need not be limited to these illustrative embodiments. The concepts described herein can be equally applicable to manufacturing of other materials, such as crumb materials, for example.

Additionally, the specific configurations, choice of materials, and the size and shape of various elements could be varied according to particular design specifications or constraints according to the materials used and the manufacturing conditions. Such changes are intended to be embraced within the scope of the invention.

The presently disclosed embodiments are, therefore, considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A pelletizing system comprising:
an extrusion section configured to extrude a material;
a pelletizer configured to pelletize the extruded material;
a first transport component configured to direct the pellets away from the pelletizer via a transport fluid;
a de-fluidizing component configured to de-fluidize the pellets; and
at least one vacuum dryer configured to dry the de-fluidized pellets, the at least one vacuum dryer comprising:
a heating hopper configured to heat the de-fluidized pellets,
a vacuum vessel configured to de-pressurize the heated pellets to remove additional moisture from the heated pellets, and
an exit system configured to discharge the dried pellets from the vacuum dryer.

2. The pelletizing system of claim 1, wherein the heating hopper is in communication with a heat source.

3. The pelletizing system of claim 2, wherein the heat source comprises a blower and a heating element, the blower being configured to direct air proximate the heating element and into the heating hopper.

4. The pelletizing system of claim 1, wherein the heating hopper comprises a screen for separating the pellets from the transport fluid.

5. The pelletizing system of claim 1, wherein the heating hopper comprises a mixer configured to mix the pellets within the heating hopper as the pellets are heated.

6. The pelletizing system of claim 1, wherein the vacuum vessel comprises at least one heating element configured to heat the pellets.

7. The pelletizing system of claim 1, further comprising:
a pellet discharge component configured to package, bag, and/or store the dried pellets; and
a final transport component configured to direct the dried pellets away from the vacuum dryer to the pellet discharge component.

8. The pelletizing system of claim 1, further comprising a second transport component configured to direct the de-fluidized pellets from the de-fluidizing component to the at least one vacuum dryer, and a third or final transport component configured to direct the dried pellets away from the exit system.

9. The pelletizing system of claim 8, wherein at least one of the transport components comprises one or more of a blower, a cyclone separator, and a conveyor.

10. The pelletizing system of claim 1, wherein the vacuum vessel is de-pressurized to a pressure greater than 0 mm Hg and less than atmospheric pressure.

11. The pelletizing system of claim 10, wherein the vacuum vessel is de-pressurized to a pressure of 70 mm Hg, +/−20 mm Hg.

12. The pelletizing system of claim 1, wherein the at least one vacuum dryer comprises more than one vacuum dryers in series, the pelletizing system further comprising additional transport components, each additional transport component configured to direct pellets from the exit system of one of the more than one vacuum dryers to the heating hopper of the next vacuum dryer of the more than one vacuum dryers in series.

13. The pelletizing system of claim 1, wherein the at least one vacuum dryer comprises a first vacuum dryer and a second vacuum dryer, the pelletizing system further comprising a diverter valve configured to direct a first portion of the de-fluidized pellets to the first vacuum dryer and a second portion of the de-fluidized pellets to the second vacuum dryer.

14. A system for drying particulate materials, the system comprising:
a de-fluidizer configured to de-fluidize a flow of particulates and fluid, the de-fluidizer comprising one or more of
a screen device configured to separate a portion of the fluid from the particulates,
a fines removal sieve configured to remove fines from the flow of the particulates and the fluid, and
a centrifugal dryer having a rotor with lifting blades and a screen circumferentially surrounding the rotor, the centrifugal dryer being configured to remove a portion of the fluid from the particulates;
a transport component configured to direct the de-fluidized particulates away from the de-fluidizer; and
at least one vacuum dryer configured to dry the de-fluidized particulates, the vacuum dryer comprising:
a heating hopper configured to heat the de-fluidized particulates,
a vacuum vessel configured to de-pressurize the heated particulates to remove additional moisture from the heated particulates, and
an exit system configured to discharge the dried particulates from the vacuum dryer.

15. The system of claim 14, wherein the heating hopper is in communication with a heat source, the heat source comprises a blower and a heating element, and the blower is configured to direct air over the heating element and into the heating hopper.

16. The system of claim 14, wherein the heating hopper comprises a mixer configured to mix the pellets within the heating hopper as the pellets are heated.

17. The system of claim 14, wherein the transport component comprises one or more of a blower, a cyclone separator, and a conveyor.

18. The system of claim 14, wherein the vacuum vessel is de-pressurized to a pressure greater than 0 mm Hg and less than atmospheric pressure.

19. The system of claim 18, wherein the vacuum vessel is de-pressurized to a pressure of 70 mm Hg, +/−20 mm Hg.

20. The system of claim 14, wherein the at least one vacuum dryer comprises more than one vacuum dryers in series, the system further comprising additional transport components, each additional transport component configured to direct particulates from the exit system of one of the more than one vacuum dryers to the heating hopper of the next vacuum dryer of the more than one vacuum dryers in series.

21. The system of claim 14, wherein the at least one vacuum dryer comprises a first vacuum dryer and a second vacuum dryer, the system further comprising a diverter valve configured to direct a first portion of the de-fluidized particulates to the first vacuum dryer and a second portion of the de-fluidized particulates to the second vacuum dryer.

22. A method of pelletizing a material, the method comprising:
extruding the material;
pelletizing the material;
immersing the pellets in a transport fluid;
de-fluidizing the pellets;
drying the de-fluidized pellets in at least one vacuum dryer comprising a heating hopper and a vacuum vessel, wherein drying the de-fluidized pellets comprises:
directing the de-fluidized pellets and a flow of heated air into the heating hopper,
mixing the de-fluidized pellets and the heated air within the heating hopper to heat the pellets, and
de-pressurizing the heated pellets in the vacuum vessel to dry the heated pellets, and
discharging the dried pellets from the at least one vacuum dryer; and
one or more of packaging, bagging, storing, and using the dried pellets.

23. The method of claim 22, wherein de-fluidizing the pellets comprises separating, via a screen device having an angled screen, a portion of the transport fluid from the pellets.

24. The method of claim 22, wherein de-fluidizing the pellets comprises removing a portion of the transport fluid from the pellets by directing the pellets through a centrifugal dryer.

25. A pelletizing system comprising:
means configured to extrude a material;
a pelletizer configured to pelletize the extruded material;
a first transport component configured to direct the pellets away from the pelletizer via a transport fluid;
a de-fluidizing component configured to de-fluidize the pellets; and
at least one vacuum dryer configured to dry the de-fluidized pellets, the at least one vacuum dryer comprising:
a staging hopper for collecting and temporarily storing de-fluidized pellets,
a heating hopper configured to receive de-fluidized pellets from the staging hopper and to heat the de-fluidized pellets,
a vacuum vessel configured to de-pressurize the heated pellets to remove additional moisture from the heated pellets, and
an exit system configured to discharge the dried pellets from the vacuum dryer.

26. A method of drying a continuous flow of particulate material combined with a transport fluid, the method comprising:
de-fluidizing the particulate material to remove a majority of the transport fluid;
drying the de-fluidized particulate material in at least one vacuum dryer comprising a staging hopper, a heating hopper, and a vacuum vessel, wherein drying the de-fluidized particulate material comprises:
directing the de-fluidized particulate material to a staging hopper to temporarily collect and store the particulate material;
directing the de-fluidized particulate material from the staging hopper to the heating hopper;
directing a flow of heated air into the heating hopper;
mixing the de-fluidized particulate material and the heated air within the heating hopper to heat the particulate material, and
de-pressurizing the heated particulate material in the vacuum vessel to dry the heated particulate material, and
discharging the dried particulate material from the at least one vacuum dryer, and
one or more of packaging, bagging, storing, and using the dried particulate material.

27. The method of claim 26, wherein the step of de-fluidizing reduces external moisture of the material to no more than approximately 3% by weight.

28. The method of claim 26, wherein the dried particulate material has a moisture content of no more than approximately 0.1% by weight and preferably no more than approximately 0.05% by weight.
